(19) United States
(12) Patent Application Publication
(10) Pub. No.: US 2002/0004024 A1
(43) Pub. Date: Jan. 10, 2002

(54) Exhaust-gas cleaning system for a combustion device and process for performing desulphating operations

(76) Inventor: Andreas Hertzberg, Stuttgart (DE)

Correspondence Address: KENYON & KENYON, ONE BROADWAY, NEW YORK, NY, 10004, US

(21) Appl. No.: 09/861,302

(22) Filed: May 18, 2001

(30) Foreign Application Priority Data
May 20, 2000 (DE) 100 25 044.0

(51) Int. Cl. B01D 53/48; B01D 53/94

(52) U.S. Cl. 423/224; 423/542; 422/171; 422/172; 422/177; 423/244.01; 423/213.2

(57) ABSTRACT

In an exhaust-gas cleaning system and method for performing desulphating operations, a catalytic converter having oxidation properties is connected downstream of an NOx-adsorber, and a secondary-air feed device is provided between the NOx-adsorber and the catalytic converter having oxidation properties. The feed device is connected to a control device so that secondary air is introduced between the NOx-adsorber and the catalytic converter having oxidation properties during the desulphating operations.

### FIELD OF THE INVENTION

The present invention relates to an exhaust-gas cleaning system for a combustion device, in particular for a motor vehicle internal-combustion engine, having an NOx-adsorber and having a control device for performing desulphating operations on the NOx-adsorber with a rich exhaust-gas composition, and to a process for performing desulphating operations in an NOx-adsorber of an exhaust-gas cleaning system.

### BACKGROUND INFORMATION

European Published Patent Application No. 0 869 263 describes a method to clean stored sulphur out of NOx-adsorbers of an exhaust-gas cleaning system for an internal-combustion engine by performing a suitable desulphating operation. During this operation, the NOx-adsorber is operated for a prolonged period at temperatures of preferably over 600° C. and with a rich exhaust-gas composition. As a result, the sulphates which have formed become unstable and are desorbed. The significant sulphur compounds emitted as a result are sulphur dioxide and hydrogen sulphide. Hydrogen sulphide in particular has an extremely pungent odor and even at low concentrations causes an unacceptable odor pollution.

It is an object of the present invention to provide an exhaust-gas cleaning system and a process that ensure a considerable reduction in the odor pollution caused by hydrogen sulphide.

### SUMMARY

For an exhaust-gas cleaning system, the above and other beneficial objects of the present invention are achieved by the fact that a catalytic converter with oxidation properties is connected downstream of the NOx-adsorber and that a secondary-air feed device is provided between the NOx-adsorber and the catalytic converter with oxidation properties, which feed device is connected to the control device so that secondary air is introduced between NOx-adsorber and catalytic converter with oxidation properties during the desulphating operations. The present invention is based on the principle that, during the desulphating operation, the hydrogen sulphide, on account of the rich exhaust-gas composition and the consequent lack of oxygen, cannot be directly oxidized by the oxygen which is present in the exhaust gas. The supply of secondary air downstream of the NOx-adsorber and upstream of a subsequent catalytic converter with oxidation properties ensures that a sufficient quantity of oxygen is present to serve as a reaction partner for the hydrogen sulphide. It is not necessary to record the exact amount of secondary air which is blown in. The only condition is that there be sufficient oxygen for complete conversion of the hydrogen sulphide into sulphur dioxide and water in the downstream catalytic converter. The fact that it is possible to subsequently convert hydrogen sulphide into sulphur dioxide enables the measure used for desulphating to be selected without attention having to be paid to the emission of hydrogen sulphide which occurs downstream of the NOx-storage catalytic converter. It is thus possible to select a measure that is simple to implement and allows rapid desulphating. The solution according to the present invention is particularly suitable for use in an exhaust-gas cleaning system of a motor vehicle internal-combustion engine, both a gasoline engine and a diesel engine. In principle, however, the solution according to the present invention may also be used for stationary combustion devices, for example in power plants.

Although European Published Patent Application No. 0 581 279 describes an exhaust-gas cleaning system for an internal-combustion engine in which an oxidation catalytic converter is connected downstream of a nitrogen oxide adsorber and in which secondary air is supplied between the nitrogen oxide adsorber and the oxidation catalytic converter, the exhaust-gas cleaning system is only used to oxidize unburnt components of the exhaust gas which flows through the nitrogen oxide adsorber, namely HC and CO, downstream of the nitrogen oxide adsorber. No reference is made, however, to desulphating of the nitrogen oxide adsorber.

The catalytic converter with oxidation properties may be designed as a three-way catalytic converter with a high oxygen storage capacity. The result is particularly successful and reliable exhaust-gas cleaning.

The NOx-adsorber and the catalytic converter with oxidation properties may be integrated in a common housing, and the secondary-air feed device may open into the housing between a monolith of the NOx-adsorber and a monolith of the catalytic converter with oxidation properties. This arrangement results in a particularly compact design which is simple to produce.

The volume of the downstream catalytic converter with oxidation properties may be significantly smaller than the volume of the NOx-adsorber, i.e., of the NOx storage catalytic converter.

The secondary-air feed device may include a pump device. Secondary-air pumps of this type are already in use in mass-produced motor vehicles.

The secondary-air feed device may be in communication with a compression device assigned to the combustion device. This arrangement may be advantageous in the case of supercharged internal-combustion engines, since in this case the compression device which is already present may also be used for the secondary-air feed device in order to blow in the secondary air between NOx-adsorber and oxidation catalytic converter. It is also possible to provide a separator compressor for introducing the secondary air into the exhaust system.

The control device may be designed so that signals from an oxygen probe connected downstream of the catalytic converter with oxidation properties are not evaluated while secondary air is being introduced by the secondary-air feed device. Oxygen sensors of this type are used as diagnosis probes or for lambda control of the internal-combustion engine and therefore for controlling the lean-burn and rich-burn operating phases. Since the quantity of secondary air supplied is not defined, evaluating corresponding signals from the oxygen sensor while recording the secondary air blown in would lead to incorrect control of the exhaust gas. This configuration therefore ensures that the exhaust-gas cleaning system with downstream oxygen sensor, in particular lambda probe, operates reliably and without problems.

With regard to the process for performing desulphating operations in which the NOx-adsorber is operated with a lean exhaust-gas composition in particular at temperatures of over 600° C., the object of the present invention is achieved by the fact that the hydrogen sulphide which is released during the desulphating operation is reoxidized by the introduction of secondary air downstream of the NOx-adsorber and is converted into sulphur dioxide and water at a catalytic converter. The conversion of hydrogen sulphide into sulphur dioxide and water significantly reduces the odor pollution caused by the emerging exhaust gas, since the odor pollution from sulphur dioxide is considerably lower than that of hydrogen sulphide. Water is known to be odor-free.

### BRIEF DESCRIPTION OF THE DRAWING

FIG. 1 is a schematic view of an example embodiment of an exhaust-gas cleaning system for a combustion device according to the present invention.

### DETAILED DESCRIPTION

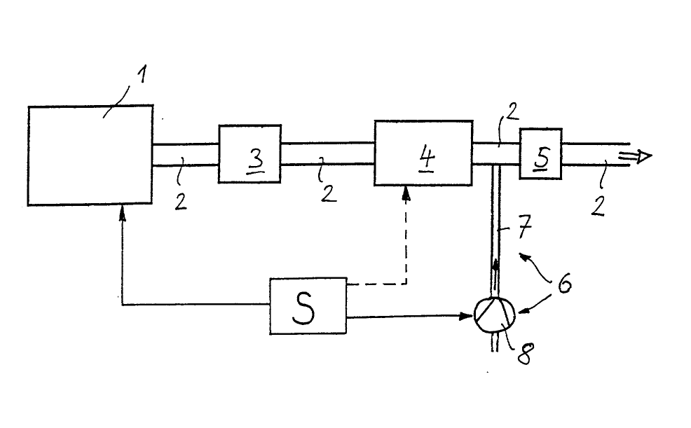

FIG. 1 is a schematic view of an exhaust-gas cleaning system for an internal-combustion engine 1 of a motor vehicle. The internal-combustion engine 1 may be a lean-burn spark-ignition engine or a diesel engine. The exhaust gas from the internal-combustion engine 1 is guided, in a conventional manner through an exhaust system 2, in which a start-up catalytic converter 3, an NOx-adsorber catalytic converter 4 and a catalytic converter 5 with oxidation properties, which is connected downstream of the NOx-adsorber catalytic converter, are arranged in this order downstream of one another, based on the direction of flow of the exhaust gas. The downstream catalytic converter with oxidation properties may be designed purely as an oxidation catalytic converter or may be designed as a three-way catalytic converter. The catalytic converter coating may be designed so that the catalytic converter has a pronounced capacity to store oxygen. An oxygen sensor, which serves as a lambda probe and is connected to a combustion control unit, which in turn controls the lean-burn or rich-burn mode of the internal-combustion engine 1, may be provided on the outlet side of the catalytic converter 5, in a conventional manner, which is not illustrated in more detail. This arrangement requires no further explanation, since it is sufficiently conventional for an internal combustion engine to be operated in this manner.

The start-up catalytic converter 3 is provided to ensure reliable exhaust-gas cleaning in the cold-start phase of the internal-combustion engine 1 and is conventional, so that this start-up catalytic converter 3 requires no further explanation herein. Also, the start-up catalytic converter 3 is not required as a component of the exhaust-gas cleaning system. The exhaust system 2 may also have the NOx-adsorber catalytic converter 4 directly adjoining the internal-combustion engine 1.

The functions of the NOx-adsorber catalytic converter 4 are also conventional. The NOx-adsorber catalytic converter 4 is alternately operated in adsorption and desorption mode in accordance with an electronic combustion control unit S, depending on whether lean-burn or rich-burn operating phases of the internal-combustion engine are set. In view of the low fuel consumption in lean-burn mode, it is desirable for the rich-burn operating phases required to be kept as short as possible. During lean-burn mode, the nitrogen oxides emitted are captured in the nitrogen-oxide adsorber catalytic converter 4 and are thus removed from the exhaust-gas stream. The changeover to desorption mode, i.e., to a rich-burn operating phase of the engine, occurs as soon as the ability of the nitrogen-oxide adsorber catalytic converter 4 to take up nitrogen oxides is exhausted.

When using sulphur-containing fuels for the internal-combustion engine 1, as is the case with fuels for motor vehicle internal-combustion engines, in addition to the nitrogen oxides the sulphur which is contained in the exhaust gas is also accumulated in the NOx-adsorber catalytic converter 4 in the form of sulphate. This incorporation of sulphur causes the storage capacity of the NOx-adsorber catalytic converter to be reduced more rapidly.

In order to destabilize and desorb the sulphates which have built up in the NOx-adsorber catalytic converter 4, the combustion control unit S is designed so that it may perform desulphating operations on the NOx-adsorber catalytic converter 4. By suitable control of the combustion control unit S, therefore, the desired function at the NOx-adsorber catalytic converter 4 is achieved, as illustrated schematically by the dashed line with an arrow illustrated in FIG. 1. In accordance with the corresponding desulphating control, the NOx-adsorber catalytic converter 4 and therefore also the exhaust system are thus operated, for a certain period, at temperatures of preferably over 600° C. and with a rich exhaust-gas composition. As a result, sulphur compounds are emitted, these compounds substantially being composed of sulphur dioxide and hydrogen sulphide. To prevent a pungent odor with the corresponding odor pollution from occurring as a result of the hydrogen sulphide being emitted at the outlet of the exhaust system 2, the catalytic converter 5 with oxidation properties, in which the hydrogen sulphide may react with oxygen and may thus be converted into sulphur dioxide and water, is provided downstream of the NOx-adsorber catalytic converter 4.

However, since there is a rich exhaust-gas composition during the desulphating operation and therefore there is an absence of the oxygen required for the oxidation of the hydrogen sulphide, secondary air is blown into the exhaust system 2 between the NOx-adsorber catalytic converter 4 and the catalytic converter 5 with oxidation properties, by a secondary-air feed device 6 which must be adequately dimensioned to ensure that there is sufficient oxygen for the reaction of the hydrogen sulphide. The secondary-air feed device 6 includes a feed line 7, which opens into the exhaust system 2. Moreover, there is a delivery device 8 which ensures that the secondary air is blown under pressure into the exhaust system. This delivery device, which may include a conventional secondary-air pump, a separate compressor or a compression device in the form of a turbocharger of the internal-combustion engine 1, is activated by the desulphating control of the combustion control unit S so that secondary air is only blown in during a desulphating operation. The volume of the catalytic converter 5 with oxidation properties is significantly smaller than the volume of the NOx-adsorber catalytic converter 4 and may also be smaller than the volume of the start-up catalytic converter 3.

The combustion control unit S with the corresponding desulphating control may be designed so that the corresponding data signals from the oxygen sensor positioned downstream of the catalytic converter 5 with oxidation properties for the purpose of lambda control are not taken into consideration or evaluated while the secondary air is being blown in by the secondary-air feed device 6, in order not to cause false results and control commands with regard to combustion.

What is claimed is:

1. An exhaust-gas cleaning system for a combustion device, comprising:
an NOx-adsorber;
a control device configured to perform a desulphating operation on the NOx-adsorber with a rich exhaust-gas composition;
a catalytic converter having oxidation properties connected downstream of the NOx-adsorber; and
a secondary-air feed device arranged between the NOx-adsorber and the catalytic converter having oxidation properties, the feed device being connected to the control device so that secondary air is introduced between the NOx-adsorber and the catalytic converter having oxidation properties during the desulphating operation.

2. The exhaust-gas cleaning system according to claim 1, wherein the combustion device includes a motor vehicle internal-combustion engine.

3. The exhaust-gas cleaning system according to claim 1, wherein the cat alytic converter having oxidation properties includes a three-way catalytic converter having a high oxygen storage capacity.

4. The exhaust-gas cleaning system according to claim 1, wherein the NOx-adsorber and the catalytic converter having oxidation properties are integrated in a common housing, the secondary-air feed device opening into the housing between a monolith of the NOx-adsorber and a monolith of the catalytic converter having oxidation properties.

5. The exhaust-gas cleaning system according to claim 1, wherein the secondary-air feed device includes a pump device.

6. The exhaust-gas cleaning system according to claim 1, wherein the secondary-air feed device includes a separate compressor.

7. The exhaust-gas cleaning system according to claim 1, wherein the secondary-air feed device is in communication with a compression device assigned to the combustion device.

8. The exhaust-gas cleaning system according to claim 1, wherein the control device is configured so that signals from an oxygen sensor connected downstream of the catalytic converter having oxidation properties are not evaluated while secondary air is being introduced by the secondary-air feed device.

9. A method for performing a desulphating operation in an NOx-adsorber of an exhaust-gas cleaning system for a combustion device, comprising the steps of:
operating the NOx-adsorber with a rich exhaust-gas composition;
introducing secondary air downstream of the NOx-adsorber;
reoxidizing released hydrogen sulphide in accordance with the introduced secondary air; and
converting the released hydrogen sulphide into sulpher dioxide and water by a catalytic converter.
